(19) United States
(12) Patent Application Publication
(10) Pub. No.: US 2015/0020616 A1
(43) Pub. Date: Jan. 22, 2015

(54) Translucent Display Cabinet with Built in Gyroscope and Servomotors

(71) Applicant: Alfonso Fabian de la Fuente Sanchez, Victoria (CA)

(72) Inventor: Alfonso Fabian de la Fuente Sanchez, Victoria (CA)

(73) Assignee: Holografyx Canada Inc., Esquimalt (CA)

(21) Appl. No.: 14/254,554

(22) Filed: Apr. 16, 2014

(51) Int. Cl. A47F 3/11; G01C 19/00; A47F 3/00

(52) U.S. Cl. CPC A47F 3/11; A47F 3/001; G01C 19/00
USPC 74/5.4

(57) ABSTRACT

This invention provides an improved Retail Display Cabinet with built in Gyroscope and servomotors to be primarily use at retail stores to showcase an item behind a transparent LCD. The Retail Display Cabinet has inside enough diffused light to better help the clear LCD display better quality images and/or videos. It has a built in gyroscope that identifies the position of the unit to determine the screen layout relevant to the aspect ratio of the screen to direct the lighting where is required. It also has built in servomotors to better show the product inside by rotating the product according to the pre-programmed commands.

### FIELD

Electronic Display Boxes

### BACKGROUND

Marketing display units at retail spaces constantly evolve to make the showcase product more attractive to prospective customers. Until recently, most of the display units had some things in common such as: well lighted, some printed matter and security features to either prevent the robbery of the display unit itself or the showcased item.

In the past years, as the use of liquid crystal display units, commonly known as flat screen displays, have been more common in the retail industry specially in the high end shops and as retail space is mostly scarce and highly valuable to retailers, new ways of showcasing an item are required by the marketing creative people.

By utilizing a transparent or translucent liquid crystal display in front of a well lighted showcase box, our translucent display cabinet with built in gyroscope and servomotors can showcase a promotional item inside our unit and at the same time display static or active images or videos in front of the product utilizing a transparent or translucent LCD screen.

A translucent or transparent LCD screen is usually a rectangular shaped object with one side longer than the other making the unit to have two different layout possibilities, horizontal or vertical. As light needs to be directed some times from the bottom or top of the unit and not from its sides it becomes important to be able to switch between light positioning in a more automated manner other than pressing a switch. Our solution provides a way to make that switch by installing a gyroscopic sensor within the unit, whereas it identifies the layout positioning of the unit performing the appropriate lightning selection.

Another feature is the servomotor driven rotating telescopic platform that rotates the showcased product at the programmers instructions at specific speeds and partial or full rotating cycles.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1, is a schematics diagram of how the different components are connected within the display cabinet.

FIG. 2 is a front upper perspective view of the Display Cabinet.

FIG. 3 is side perspective view of the Display Cabinet.

FIG. 4 is an exploded side perspective view of the Display Cabinet.

FIG. 5 is a front view of the Display Cabinet.

FIG. 6 is a sectional view in reference from numerals 6 of FIG. 5.

FIG. 7 is a side view of the display cabinet.

FIG. 8 is a sectional view in reference from numerals 8 of FIG. 7.

FIG. 9 is a front view of the display cabinet in a horizontal position.

FIG. 9a is a front view of the Display Cabinet in a vertical position.

FIG. 10 is a front view of the rotating base assembly

FIG. 11 is a front top perspective view of the rotating base assembly

FIG. 12 is a front bottom perspective view of the rotating base assembly.

FIG. 13 is a front view of the display cabinet with a rotating base installed.

FIG. 13a is a front top perspective view of the display cabinet with a rotating base installed.

FIG. 14 is a top view of the servomotor unit.

FIG. 15 is a side view of the servomotor unit.

FIG. 16 is an exploded side view of the rotating base assembly connecting to the servomotor through a cavity in the diffuser sheet.

FIG. 17 is a side view of the rotating base assembly connected to the servomotor through a cavity in the diffuser sheet to the servomotor.

FIG. 18 is a top view of the rotating platform's platform in a 0 degree rotation exemplification.

FIG. 19 is a top view of the rotating platform's platform rotating at 80 degrees.

FIG. 20 is a top view of the rotating platform's platform rotating at 80 degrees.

FIG. 21 is a front perspective view of the rotating platform with the base retracted.

FIG. 22 is a front perspective view of the rotating platform with the base half extended.

FIG. 23 is a front perspective view of the rotating platform with the base fully extended.

### DETAILED DESCRIPTION

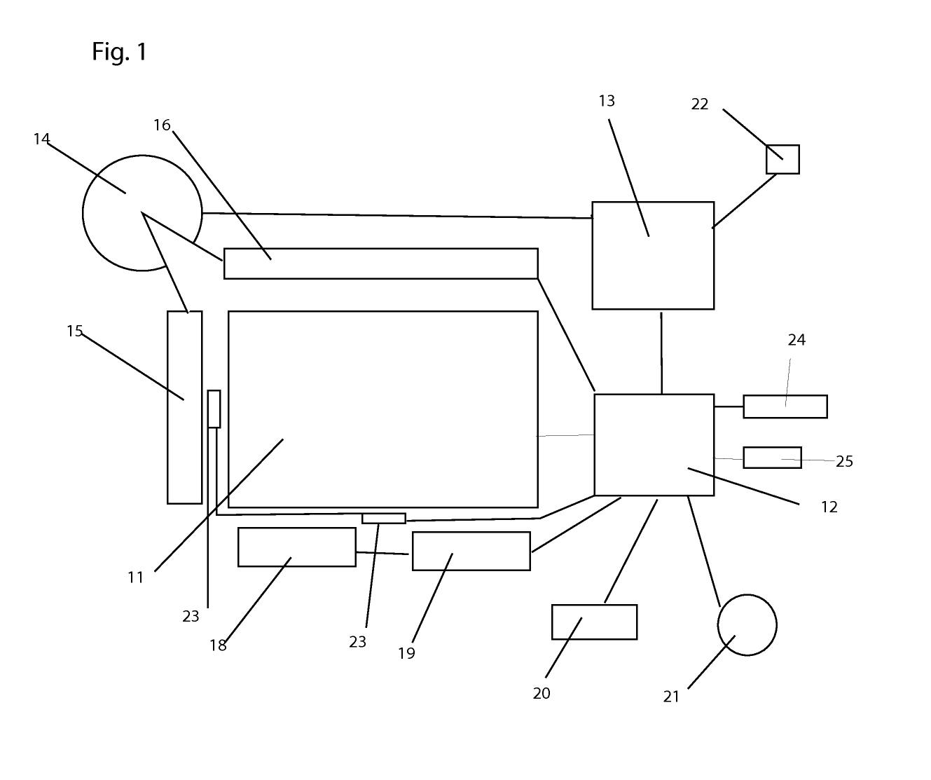

A display cabinet with built in gyroscope and servomotors generally identified by reference numeral (3) will now be described with reference to FIG. 1 through 20.

### Operation

Referring to FIG. 1, a Power Supply Unit (13) distributes power to a Monitor Controller Board (12), and to a Gyroscope driven power distribution switch (14).

The monitor controller board (12) sends a video signal to the transparent LCD (11), commands to the Light Emitting Diode Panels “LED”s (15, 16) and to the servomotors (23) and audio signals to the Left (18) and Right Speakers (19).

The monitor controller board (12) also has an external USB input panel (20) and a mechanical electric switch (21) as well as a main keyboard (24) and an IR receiver (25) for remote infrared operation.

If the Gyroscope driven power distribution switch (14) detects that the unit is in Horizontal position, it distributes the power sent by the Monitor controller board (12) to the Horizontal LED module (15). If the Gyroscope driven power distribution switch (14) detects that the unit is in Vertical position, it distributes the power sent by the Monitor controller board (12) to the Vertical LED module (16).

The monitor controller board (12) may also decode signals and control the servomotors (15 or 16) to display in different positions the selected product inside the Display Cabinet.

Structure and relationship of Parts:

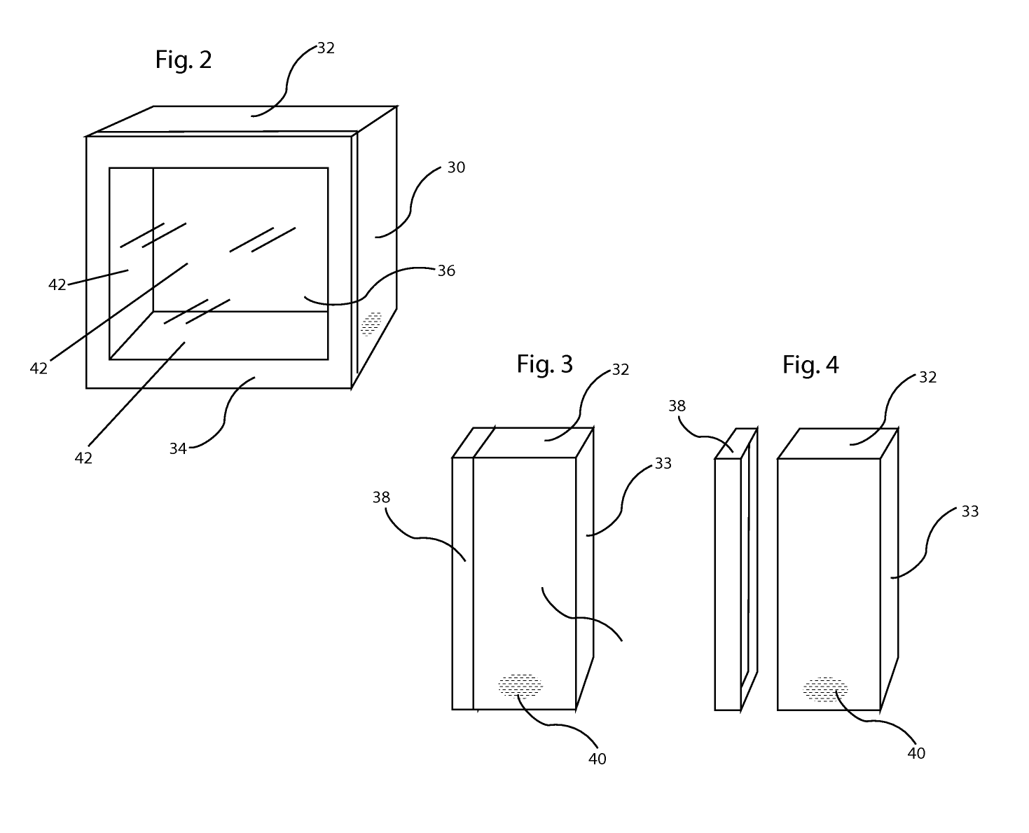

Referring to FIGS. 2, 3 and 4, a front bezel frame (34) supports a transparent LCD (11) making the Transparent LCD bezel assembly (38) which is affixed to the main body in FIG. 2 represented by the Top panel (32) and the side panel (30), both side panels have a speaker grill (40). The diffuser sheet diffuses the light created by the LED panels (15 and 16 not shown in this figure) to make the inside of the display cabinet brighter.

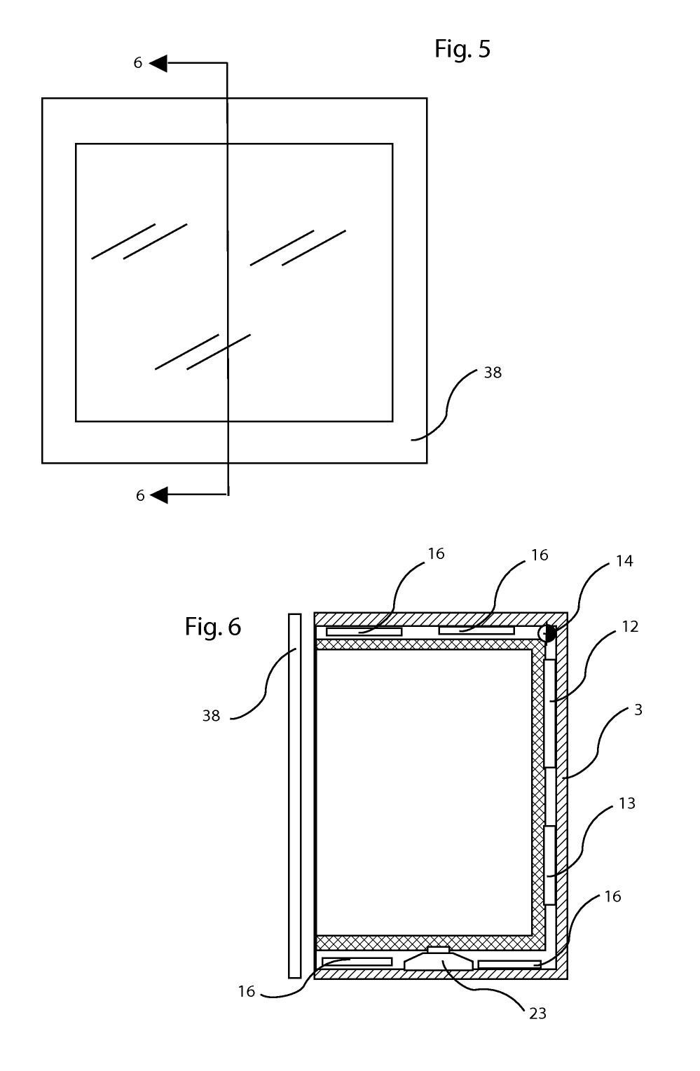

Referring to FIGS. 5 and 6, the main unit panels (33) and the diffuser sheets (42) are housed the Horizontal LED modules (16) installed in the top and bottom when the unit is in a horizontal position. A Gyroscope driven power distribution switch (14) identifies that the unit is in a horizontal position and distributes power to the LED horizontal panels (16). A Servomotor for a rotating base (23) is located at the bottom of the unit when it is in a horizontal position. A diffuser sheet (42) is used to diffuse the lights coming from the LED panels (16) and also to cover the other accessories such as the Monitor Controller Board (12), the power supply unit (13) servomotors for the rotating base.

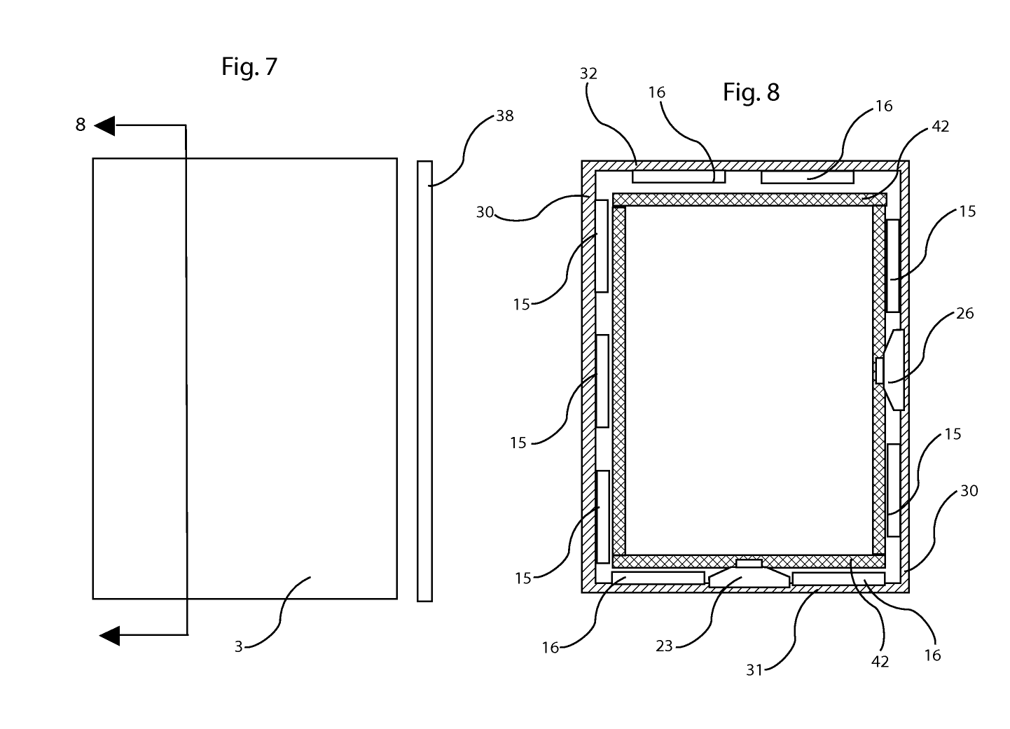

Referring to FIGS. 7 and 8, FIG. 8 is a sectional view from FIG. 7 representing the outside panels of the main unit (3) including the side panels (30) and the bottom (31) and top panels (32), attached to those panels are at the top the Horizontal LED Modules (16) at the top and bottom of the unit when the unit is in a horizontal position, vertical LED modules (15) that when the unit is in a vertical position they are located at the top and bottom of the unit, also, a Servomotor for rotating base (23 or 26) that operates at the bottom of the unit whenever the unit is in a vertical or horizontal position.

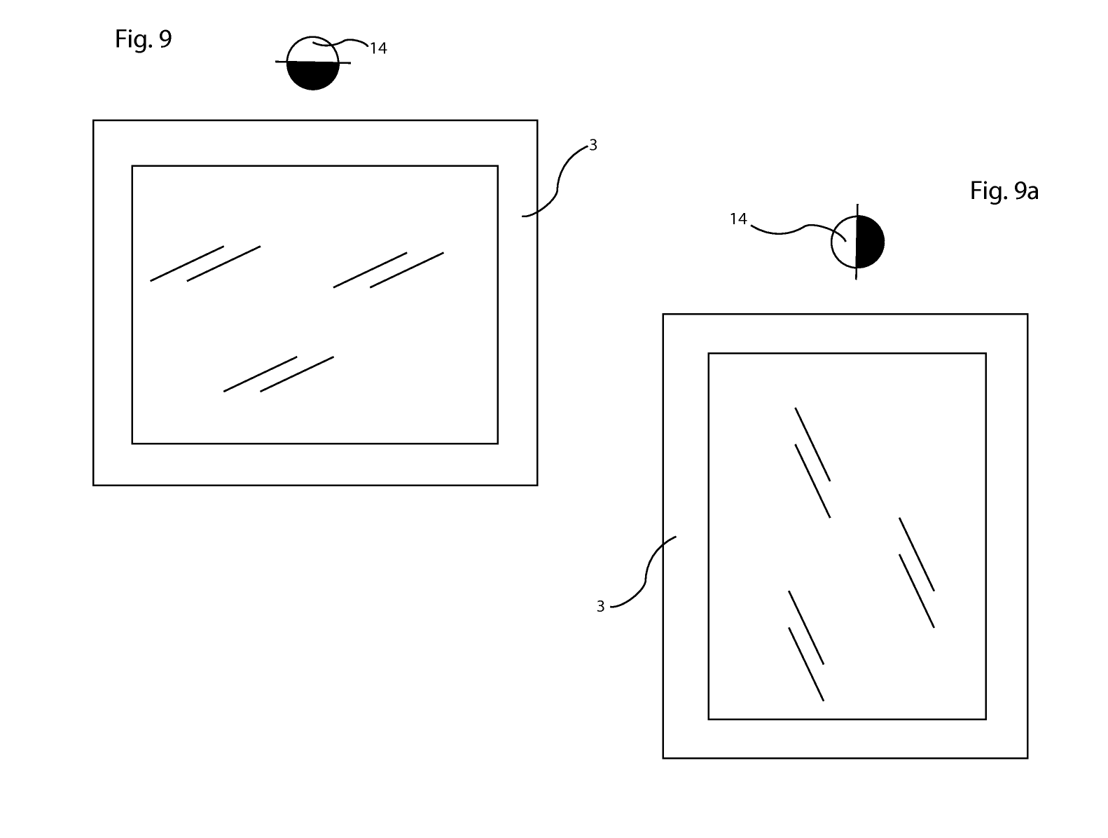

Referring to FIGS. 9 and 9a, FIG. 9 represents the Display cabinet with built in gyroscope and servomotors (3) in a horizontal position. FIG. 9a represents the Display cabinet with built in gyroscope and servomotors (3) in a vertical position. The position is identified by a Gyroscope (14).

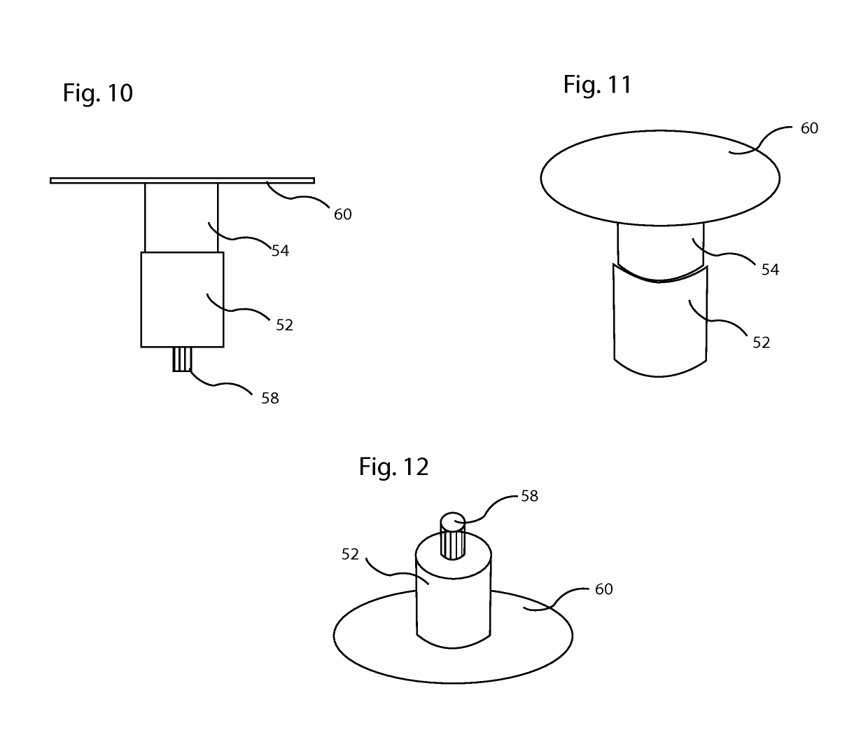

Referring to FIGS. 10 to 12, a telescopic arm (52) with two sub-sections (54 and 56) supporting a platform (60) with a shaft with a spine in the bottom that rotates when connected to a servomotor.

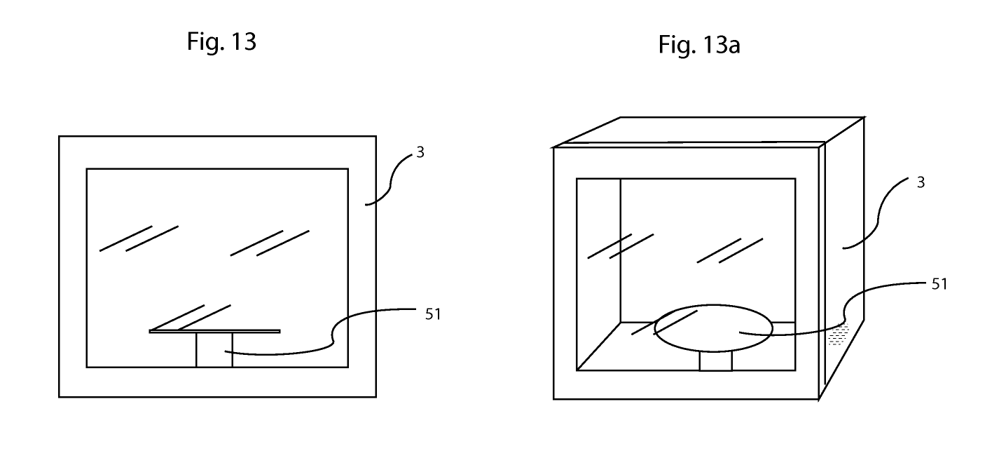

Referring to FIGS. 13 and 13a, it shows the position the rotating base assembly is installed in reference to the Display cabinet (3)

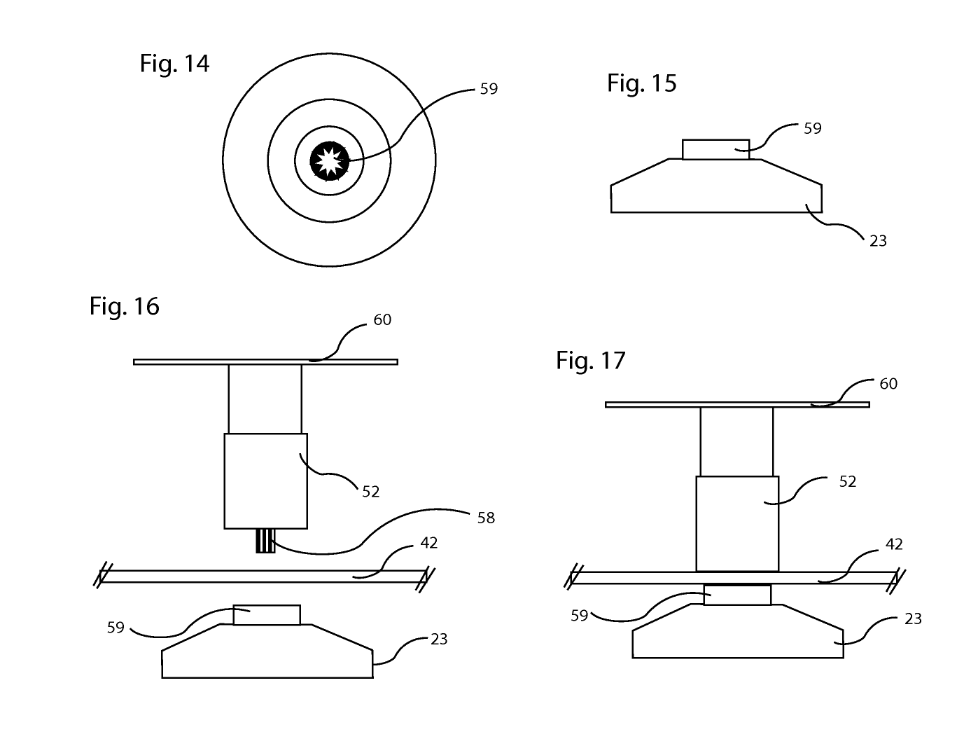

Referring to FIGS. 14 and 15, a servomotor (23) has a slot with an internal spline (59) that rotates when connected to the rotating base assembly (51)

Referring to FIGS. 16 and 17, the rotating base assembly consisting of the telescopic arm (52) with a platform (60) on one side and the shaft with a spine in the other, connect the shaft with spline to a slot with internal spine (59) at the servomotor (23), the shaft with a spline (58) needs to pass trough a cavity in the diffuser sheet (42) that separates both units in order to connect. FIG. 16 shows the units before being connected and FIG. 17 shows the units connected.

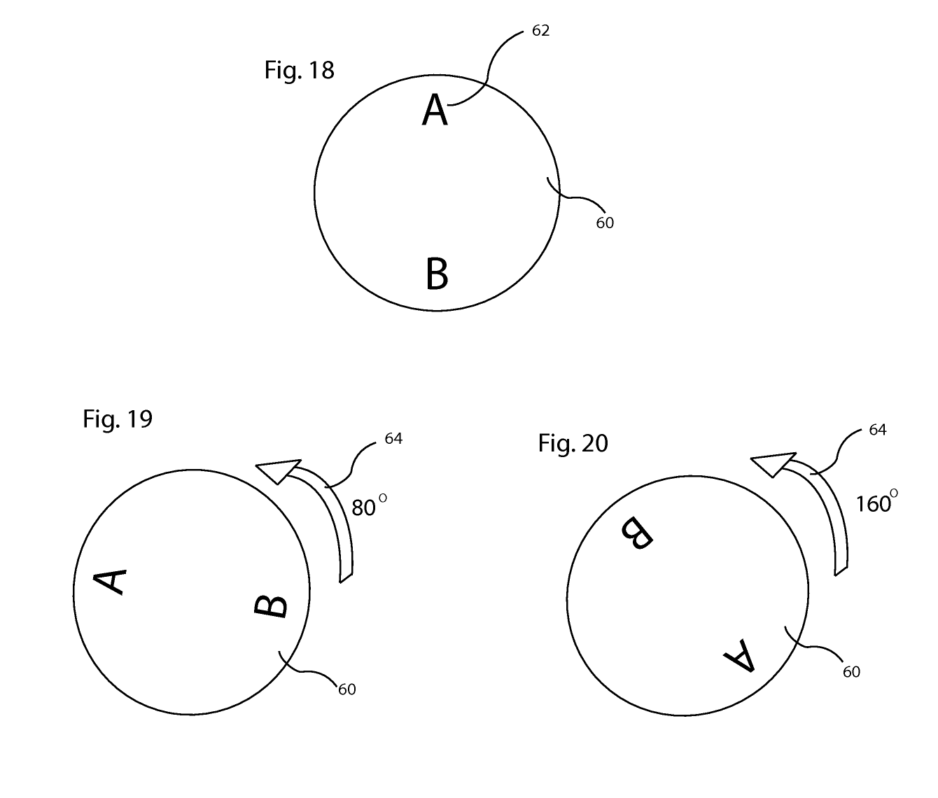

In referral to FIGS. 18 to 20, FIG. 18 shows a top view of the rotating base platform (60) is in reference to marking A (62), the platform rotates only when the Monitor Controller board (12) sends a signal with a specific command like rotate 80 degrees (64) (FIG. 19) or to rotate 160 degrees (FIG. 20) for example. The servomotor is very exact on the rotation the platform needs to take.

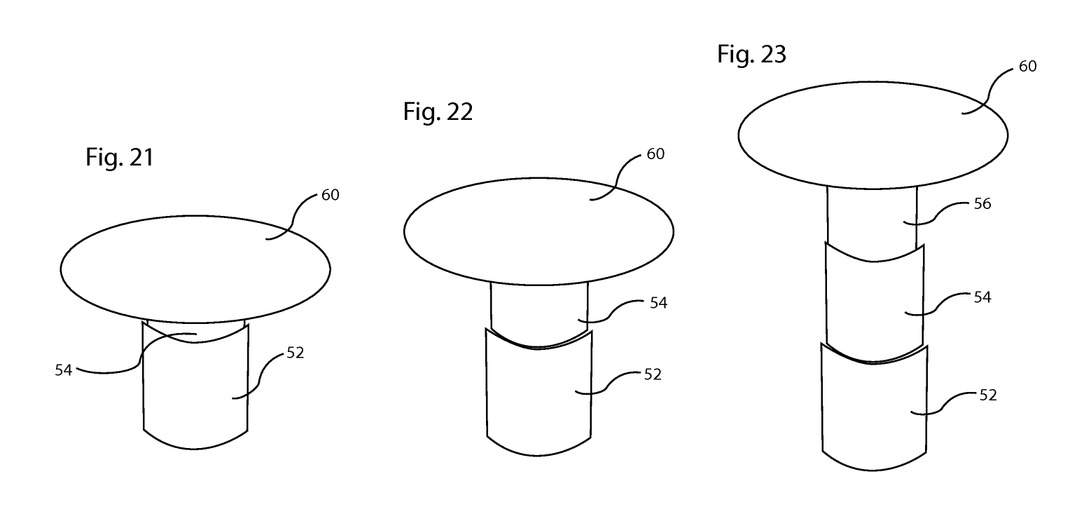

In referral to FIGS. 21 to 23, the telescopic arm (52, 53, 54) of the rotating base assembly can be manipulated to extend or retract depending the height required to showcase the product in the display cabinet.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A Display cabinet with gyroscope and servomotors comprising:
A gyroscope driven power distribution switch.

2. The Display cabinet with gyroscope and servomotors of claim 1, wherein the gyroscope driven power distribution switch distributes the electrical current depending on the layout position of the Display Cabinet unit to the corresponding Light Emitting Diodes Panels located within the cabinet walls

3. A telescopic rotating base controlled by servomotors.

4. A method of using a gyroscope driven power distribution switch to detect the Display Cabinet's layout position to properly distribute the power to the appropriate lights.

5. The method of controlling the rotation of the servomotors by the commands sent by the monitor controller board instructions.
